(19) United States
(12) Patent Application Publication
(10) Pub. No.: US 2007/0072087 A1
(43) Pub. Date: Mar. 29, 2007

(54) Non-aqueous electrolyte secondary battery

(76) Inventors: Hidekazu Yamamoto, Kobe-shi (JP); Keiji Saisho, Kobe-shi (JP)

Correspondence Address: KUBOVCIK & KUBOVCIK, SUITE 710, 900 17TH STREET NW, WASHINGTON, DC, 20006, US

(21) Appl. No.: 11/527,452

(22) Filed: Sep. 27, 2006

(30) Foreign Application Priority Data
Sep. 28, 2005 (JP) 2005-281958

(51) Int. Cl. H01M 10/36; H01M 4/58

(52) U.S. Cl. 429/344; 429/199; 429/218.1

(57) ABSTRACT

A non-aqueous electrolyte secondary battery using silicon as negative electrode active material and containing carbon dioxide in a non-aqueous electrolyte is provided that minimizes gas generation during storage in a charged state and improves charge-discharge cycle performance. The non-aqueous electrolyte secondary battery is provided with a negative electrode containing silicon as a negative electrode active material, a positive electrode, and a non-aqueous electrolyte containing electrolyte salts and a solvent. The non-aqueous electrolyte contains carbon dioxide, and the electrolyte salts include LiBF₄ and another electrolyte salt that is less consumed relative to the LiBF₄ during charge-discharge cycling.

### BACKGROUND OF THE INVENTION

1. Field of the Invention

The present invention relates to non-aqueous electrolyte secondary batteries, and more particularly to a non-aqueous electrolyte secondary battery in which silicon is contained as a negative electrode active material and carbon dioxide is contained in the non-aqueous electrolyte.

2. Description of Related Art

Significant size and weight reductions in mobile electronic devices such as mobile telephones, notebook computers, and PDAs have been achieved in recent years. In addition, power consumption of such devices has been increasing as the number of functions of the devices has increased. As a consequence, demand has been increasing for lighter weight and higher capacity lithium secondary batteries used as power sources for such devices.

Currently, carbon materials such as graphite are commonly used for negative electrodes of lithium secondary batteries. The capacity that is possible with graphite materials, however, has already reached the limit determined by the theoretical capacity (372 mAh/g), and the graphite materials no longer meet the demand for further higher battery capacity.

In order to fulfill the foregoing demand, alloy-based negative electrodes made of such materials as silicon, germanium, and tin have been proposed in recent years as materials that show higher charge-discharge capacities per unit mass and per unit volume than carbon-based negative electrodes. In particular, silicon is considered as a good candidate for a negative electrode material since silicon shows a high theoretical capacity of about 4000 mAh per 1 g of active material.

When silicon is used as a negative electrode active material, the active material expands and shrinks due to charge and discharge. Especially when silicon expands due to a charge reaction, the newly exposed surface is reactive and therefore causes a side reaction with the electrolyte solution, degrading the battery's charge-discharge cycle performance.

In order to minimize the side reaction, Published PCT Application WO 2004/109839 proposes dissolving carbon dioxide in the electrolyte solution. It is believed that by dissolving carbon dioxide in the electrolyte solution, a surface film forms on the negative electrode surface, preventing the side reaction, although the details of the mechanism of why the side reaction can be minimized are not clearly understood.

Nevertheless, the use of an electrolyte solution in which carbon dioxide is dissolved causes the problem of gas generation when the battery is stored in a charged state under high temperature. The amount of the gas generated is much larger than the amount of carbon dioxide generated by evaporating the carbon dioxide dissolved in the electrolyte solution, and therefore, it is believed that the electrolyte solution decomposes on the positive electrode side, generating the gas. Such gas generation increases the thickness and internal resistance of the battery. This is a significant problem in actual use of the battery.

### BRIEF SUMMARY OF THE INVENTION

Accordingly, it is an object of the present invention to provide a non-aqueous electrolyte secondary battery in which silicon is used as the negative electrode active material and carbon dioxide is contained in the non-aqueous electrolyte solution, the non-aqueous electrolyte secondary battery being capable of minimizing gas generation when the battery is stored in a charged state and exhibiting good charge-discharge cycle performance.

In order to accomplish the foregoing and other objects, the present invention provides a non-aqueous electrolyte secondary battery comprising a negative electrode containing silicon as a negative electrode active material; a positive electrode; and a non-aqueous electrolyte containing electrolyte salts and a solvent, wherein the non-aqueous electrolyte contains carbon dioxide, and the electrolyte salts in the non-aqueous electrolyte include LiBF₄ and another electrolyte salt that is less consumed relative to the LiBF₄ during charge-discharge cycling.

According to the present invention, a non-aqueous electrolyte secondary battery that uses silicon as a negative electrode active material and contains carbon dioxide in the non-aqueous electrolyte is provided that can prevent gas generation during storage in a charged state and improve charge-discharge cycle performance.

### DETAILED DESCRIPTION OF THE INVENTION

In the battery according to present invention, LiBF₄ is contained as an electrolyte salt so that gas generation can be minimized during storage in a charged state. Although the detailed mechanism of why gas generation can be minimized during storage in a charged state is not clear, it is believed that when LiBF₄ is contained in the non-aqueous electrolyte as an electrolyte salt, the LiBF₄ reacts with the silicon negative electrode at its surface, and a surface film containing fluorine forms on the surface of the silicon negative electrode. Since the battery of the present invention employs a silicon negative electrode, the positive electrode shows a high potential in a range of from 4.3 to 4.5V (vs. Li/Li⁺) in a charged state, so it is believed that decomposition of the electrolyte solution occurs at the positive electrode, leading to gas generation. It is believed that the reaction at the surface of the silicon negative electrode is involved in this gas generation in some way, and therefore, the gas generation can be minimized by the formation of the surface film on the surface of the silicon negative electrode, which originates from the LiBF₄.

In the battery according to the present invention, an electrolyte salt that is less consumed than the LiBF₄ in charge-discharge cycling is further contained as an electrolyte salt. Examples of the electrolyte salt other than the LiBF₄ include LiPF₆, LiN(SO₂C₂F₅)₂, and LiN(SO₂CF₃)₂. As will be discussed later, LiBF₄ is consumed in a large amount in charge-discharge cycling, and therefore, in order to compensate for the consumption of LiBF₄, an electrolyte salt other than LiBF₄ is added. The addition of the electrolyte salt other than LiBF₄ prevents shortage of electrolyte salt, making it possible to enhance the charge-discharge cycle performance of the battery.

It is preferable that the content of the LiBF₄ in the non-aqueous electrolyte is within a range of from 0.1 mol/L to 2.0 mol/L. If the content is less than 0.1 mol/L, it may not be possible to obtain the advantageous effects of the present invention that the gas generation during storage in a charged state can be minimized and at the same time the charge-discharge cycle performance can be enhanced. On the other hand, if the content exceeds 2.0 mol/L, the viscosity of the non-aqueous electrolyte increases, making it difficult to impregnate the electrode with the non-aqueous electrolyte sufficiently. This may lead to poor battery performance. It is more preferable that the content of the LiBF₄ be within a range of from 0.5 mol/L to 1.5 mol/L. It should be noted that the contents of the LiBF₄ specified here should be understood as the contents as determined at the time of assembling the battery.

In the present invention, the content of the electrolyte salt other than the LiBF₄ is preferably within a range of from 0.1 mol/L to 1.5 mol/L. If the content is less than 0.1 mol/L, the electrolyte salt may be short of what is required for compensating for the LiBF₄ that is consumed as the charge-discharge cycles are repeated and the ion conductivity of the non-aqueous electrolyte may be insufficient. This may lead to degradation in battery performance. On the other hand, if the content exceeds 1.5 mol/L, the viscosity of the non-aqueous electrolyte increases, making it difficult to sufficiently impregnate the electrolyte in the electrode. This may also lead to poor battery performance. More preferably, the content is within a range of from 0.1 mol/L to 1.0 mol/L. It should be noted that the contents of the electrolyte salt other than the LiBF₄ specified here should be understood as the contents as determined at the time of assembling the battery.

It is preferable that the mixture ratio of the LiBF₄ to the other electrolyte salt upon assembling of the battery be within a range of from 1:20 to 20:1 (LiBF₄:electrolyte salt other than LiBF₄) by weight. If the relative amount of LiBF₄ is too large, ion conductivity degrades as the charge-discharge cycling proceeds, which may degrade battery performance. On the other hand, if the relative proportion of the electrolyte salt other than the LiBF₄ is too large, the effect of minimizing the gas generation during storage in a charged state and improving charge-discharge cycle performance may not be attained sufficiently because the content of the LiBF₄ becomes relatively small.

In the present invention, it is preferable that the content of the carbon dioxide in the non-aqueous electrolyte be 0.01 weight % or greater. If the content of carbon dioxide is less than 0.01 weight %, the effect of improving the charge-discharge cycle performance achieved by dissolving carbon dioxide may not be sufficiently obtained. A more preferable content of carbon dioxide is the saturation point at the ambient temperature. Therefore, it is preferable that carbon dioxide be dissolved in the non-aqueous electrolyte in assembling the battery so that carbon dioxide will be dissolved therein to saturation.

In the present invention, the solvent for the non-aqueous electrolyte may be any non-aqueous solvent that is commonly used for non-aqueous electrolyte secondary batteries. Examples include cyclic carbonates, chain carbonates, lactone compounds (cyclic carboxylic ester), chain carboxylic esters, cyclic ethers, chain ethers, and sulfur-containing organic solvents. Preferable examples among these are cyclic carbonates, chain carbonates, lactone compounds (cyclic carboxylic ester), chain carboxylic esters, cyclic ethers, and chain ethers that have a total number of carbon atoms of 3 to 9. It is particularly preferable that a cyclic carbonate and a chain carbonate that have a total number of carbon atoms of 3 to 9 be used either alone or in combination.

It is preferable that fluoroethylene carbonate (FEC) be contained in the non-aqueous electrolyte. Adding fluoroethylene carbonate can further improve the charge-discharge cycle performance. Preferably, the content of fluoroethylene carbonate is within a range of from 0.1 weight % to 30 weight % with respect to the total weight of the solvent in the non-aqueous electrolyte.

The negative electrode in the present invention is a negative electrode employing a negative electrode active material containing silicon. Such a negative electrode may be formed by depositing a thin film containing silicon, such as an amorphous silicon thin film and a non-crystalline silicon thin film, on a negative electrode current collector made of a metal foil such as a copper foil by CVD, sputtering, evaporation, thermal spraying, or plating. The thin film containing silicon may be an alloy thin film of silicon with cobalt, iron, zirconium, and so forth. The method for fabricating such a negative electrode is disclosed in detail in Published PCT Application WO 2004/109839, for example, which is incorporated herein by reference.

In the above-described negative electrode, it is preferable that the thin film be divided by gaps that form along its thickness to form columnar structures, and that bottom portions of the columnar structures be in close contact with the negative electrode current collector. By employing such an electrode structure, spaces form around the columnar structures, and these spaces serve to absorb the change in volume due to the expansion and shrinkage of the active material, alleviating the stress associated with charge-discharge cycling. Therefore, good charge-discharge cycle performance is attained. The gaps that form along the film thickness are generally formed by charge-discharge reactions.

The negative electrode in the present invention may be formed from active material particles containing silicon. The negative electrode may be formed by applying a slurry containing the active material particles and a binder onto a current collector. Examples of the active material particles include silicon particles and silicon alloy particles.

The positive electrode active material that may be used in the present invention is not particularly limited as long as it can be used for non-aqueous electrolyte batteries. Examples include lithium transition metal oxides, such as lithium cobalt oxide, lithium manganese oxide, and lithium nickel oxide. These oxides may be used either alone or in combination.

The positive electrode in the present invention generally shows a potential within a range of from 4.3 V to 4.5V versus Li/Li⁺ in a charged state.

Hereinbelow, the present invention is described in further detail based on examples thereof. It should be construed, however, that the present invention is not limited to the following examples but various changes and modifications are possible without departing from the scope of the invention.

### EXAMPLES 1, 2 AND COMPARATIVE EXAMPLES 1 to 5

Preparation of Negative Electrode

A negative electrode was prepared by forming a silicon thin film on a copper foil serving as a current collector by sputtering or by evaporation, as indicated in Table 1. The specific fabrication method was as follows.

Formation of Thin Film by Sputtering

Thin films were formed on both sides of an electrolytic copper foil having a thickness of 18 μm and a surface roughness Ra of 0.188 μm by RF sputtering according to the following conditions: Flow rate of sputtering gas (Ar): 100 sccm; Substrate temperature: Room temperature (not heated); Reaction pressure: 0.133 Pa; High-frequency power: 200 W. The resultant was used as a negative electrode.

A cross-sectional SEM analysis of the current collector on which the thin films were deposited was conducted to measure the film thickness. Consequently, it was found that the thin films were deposited to a thickness of about 5 μm on both sides of the current collector. The thin films were analyzed by a measurement using Raman spectroscopy. A peak in the vicinity of a wavelength of 480 cm⁻¹ was detected, but no peaks were detected around 520 cm⁻¹. This confirmed that the deposited thin films were amorphous thin films.

Formation of Thin Film by Evaporation

Both sides of an electrolytic copper foil having a thickness of 18 μm and a surface roughness Ra of 0.188 μm were irradiated with an Ar ion beam at an ion current density of 0.27 mA/cm² at a pressure of 0.05 Pa. Thereafter, the chamber was evacuated to 1×10⁻³ Pa or less, and using single crystal silicon as the evaporation source material, thin films were formed on both sides of the electrolytic copper foil by electron beam evaporation according to the following conditions: Substrate temperature: Room temperature (not heated); Input power: 3.5 kW. The resultant was used as a negative electrode.

A cross-sectional SEM analysis of the current collector on which the thin films were deposited was conducted to measure the film thickness. Consequently, it was found that the thin films were deposited to a thickness of about 7 μm on both sides of the current collector. The thin films were analyzed by a measurement using Raman spectroscopy. A peak in the vicinity of a wavelength of 480 cm⁻¹ was detected, but no peaks were detected around 520 cm⁻¹. This confirmed that the deposited thin films were amorphous thin films.

Preparation of Positive Electrode

Lithium cobalt oxide as a positive electrode active material, Ketjen Black as a conductive agent, and fluororesin as a binder agent were mixed together at a weight ratio of 90:5:5, and the resultant mixture was dissolved in N-methyl-2-pyrrolidone (NMP) to prepare a paste.

The resultant paste was applied uniformly onto both sides of an aluminum foil having a thickness of 20 μm by doctor blading. Next, in a heated dryer, the resultant material was annealed in a vacuum at 100° C. to 150° C. to remove the NMP, and thereafter pressure-rolled with a roll presser so that the thickness became 0.16 mm. Thus, a positive electrode was prepared.

Preparation of Electrolyte Solution

LiBF₄ and/or LiPF6 as electrolyte salt(s) was/were dissolved into a mixed solvent of 3:7 volume ratio of ethylene carbonate (EC) and diethyl carbonate (DEC) so that their contents were as set forth in Table 1 below. For the examples in Table 1 that are indicated as “Yes” in the column “CO₂ saturated”, carbon dioxide was dissolved in the electrolyte solution to saturation. At this time the content of carbon dioxide was 0.4 weight %. The content of carbon dioxide was obtained from the difference between the weights before and after dissolving carbon dioxide.

Preparation of Lithium Secondary Cell

The positive electrode and the negative electrode prepared in the above-described manner were cut out into predetermined dimensions, and current collector tabs were attached to the metal foils, serving as current collectors. A 20-μm thick separator made of a polyolefin-based microporous film was interposed between the electrodes to form a laminate, and this was coiled. The outermost circumference was fastened with an adhesive tape to form an electrode assembly, and thereafter the electrode assembly was pressed into a flat shape, to thus form a spirally-wound electrode assembly.

The spirally-wound electrode assembly was inserted into a battery case made of a laminated material in which PET (polyethylene terephthalate) and aluminum were layered, and the current collector tabs were made to protrude outwardly through an opening.

Next, 2 mL of the above-described electrolyte solution was filled into the battery case through the opening of the battery case, and thereafter the opening was sealed. Thus, a lithium secondary battery was fabricated. The battery thus fabricated had a discharge capacity of 250 mAh.

Charge-Discharge Cycle Test

Batteries of Examples 1 and 2 as well as Comparative Examples 1 to 5, each of which was fabricated in the above-described manner, were charged at a charge current of 250 mA until the battery voltage reached 4.2 V, thereafter further charged at a constant voltage of 4.2 V until the current value reached 13 mA, and thereafter discharged at a current of 250 mA until the battery voltage became 2.75 V, to complete one charge-discharge cycle. This charge-discharge cycle was repeated 60 times. The percentage of the discharge capacity at the 60th cycle to the discharge capacity at the first cycle was determined as capacity retention ratio (%). The results are shown in Table 1 below.

Measurement of Battery Thickness Increase after Storage in Charged State

Before being subjected to the cycle test, the batteries were stored in a charged state under high temperature. Specifically, they were stored at 60° C. for 10 days, and the battery thickness increase for each of the batteries was measured. The results are also shown in Table 1 below.

TABLE 1

| | | | | | | Battery |
|---|---|---|---|---|---|---|
| | | | | | | thickness |
| | | | | | Discharge | increase |
| | | | | | capacity | after |
| | | | | | retention | storage |
| | Nega- | | | | ratio | in a |
| | tive | CO₂ | LiPF₆ | LiBF₄ | after 60 | charged |
| | elec- | satu- | content | content | cycles | state |
| | trode | rated | (mol/L) | (mol/L) | (%) | (mm) |
| Comp. Ex 1 | Sput- | — | 1.0 | — | 28.4 | 0.26 |
| Comp. Ex 2 | tered | Yes | | | 73.9 | 1.18 |
| Comp. Ex 3 | Si | — | 0.5 | 0.5 | 58.4 | 0.07 |
| Ex. 1 | | Yes | | | 73.4 | 0.07 |
| Comp. Ex 4 | Depo- | — | 1.0 | — | 82.8 | 0.10 |
| Comp. Ex 5 | sited | Yes | | | 90.1 | 1.04 |
| Ex 2 | Si | Yes | 0.5 | 0.5 | 89.5 | 0.05 |

Comparing Example 1 and Comparative Examples 1 to 3, the negative electrodes of which have the silicon thin film formed by sputtering, it is seen that dissolving carbon dioxide in the electrolyte solution improves charge-discharge cycle performance. Nevertheless, it is seen that Comparative Example 2, which does not contain LiBF₄, shows an increase in battery thickness, which indicates that gas generation occurred. In contrast, Example 1, which uses both LiBF₄ and LiPF₆, shows good charge-discharge cycle performance and also exhibits a smaller battery thickness increase, which means that gas generation is minimized.

The same effect as above is observed with the batteries of Example 2 and Comparative Examples 4 and 5, the negative electrodes of which have the silicon thin film formed by evaporation. That is, Comparative Example 5, which does not contain LiBF₄, shows an increase in battery thickness, while Example 2, which uses both LiBF₄ and LiPF₆, shows good charge-discharge cycle performance and also exhibits a smaller battery thickness increase, which means that gas generation is minimized.

Accordingly, it is demonstrated that by dissolving carbon dioxide in the non-aqueous electrolyte and at the same time using LiBF₄ and LiPF₆ as electrolyte salts according to the present invention, gas generation in the battery can be minimized during storage in a charged state and charge-discharge cycle performance can be improved.

The amounts of the gas generated in Comparative Examples 2 and 5 were far greater than the amount of the carbon dioxide dissolved in the electrolyte solution. Specifically, in the batteries of Examples 1 and 2 according to the present invention, the amount of carbon dioxide released from the electrolyte solution as the temperature was elevated from 25° C. to 60° C. was about 1.0 cm³. In contrast, the amounts of gas generated in Comparative Examples 2 and 5 were about 5 to 10 times greater than that.

Therefore, it is believed that the gas generated during storage in a charged state is not just the carbon dioxide dissolved in the electrolyte solution but also includes a large amount of gas generated by decomposition of the electrolyte solution.

Confirmation of Consumption of LiBF₄

LiBF₄ and LiPF₆ as electrolyte salts were dissolved into a mixed solvent of 3:7 volume ratio of ethylene carbonate (EC) and diethyl carbonate (DEC) so that their content was each 0.5 mol/L. No carbon dioxide was dissolved in the electrolyte solution. A lithium secondary battery was prepared in the same manner as in Example 2 above, except that the just-described electrolyte solution was used.

A charge-discharge cycle test was conducted until the capacity retention ratio reached 30% under the same conditions as set out above, and the contents of LiBF₄ were measured before the charge-discharge cycles and after the charge-discharge cycles.

The electrolyte solution inside the battery infiltrates the interior of the separator and the electrodes so the electrolyte solution cannot be taken out merely by opening the battery in a normal way. For this reason, a portion of the laminate battery case was opened, then 1 mL of DEC was poured through the opening, and after setting the battery aside for 10 minutes, the electrolyte solution to which the DEC was added was taken out. The taken-out electrolyte solution was analyzed by ion chromatography to determine the concentrations of the electrolyte salts in the electrolyte solution. The results of the measurement are shown in Table 2 below. The values shown as relative ratio in Table 2 are values standardized by taking the concentration of LiPF₆ as 100%.

TABLE 2

| | LiPF₆ | LiBF₄ |
|---|---|---|
| Amount added upon | 0.5 M | 0.5 M |
| assembling | | |
| (absolute value) | | |
| Amount added upon | 100% | 100% |
| assembling | | |
| (relative value) | | |
| Before cycling | 100% | 96% |
| (relative ratio) | | |
| After cycling | 100% | 1.9% |
| (relative ratio) | | |

As clearly seen from Table 2, the concentrations of LiPF6 and LiBF₄ added at the time of assembling of the battery were almost the same at the initial stage, but the proportion of LiBF4 significantly lowered after the cycling, which dropped to less than 1/50 of the proportion of LiPF₆. Thus, it is understood that LiBF4 is consumed in charge-discharge cycling.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and is not intended to limit the invention as defined by the appended claims and their equivalents.

This application claims priority of Japanese patent application No. 2005-281958 filed Sep. 28, 2005, which is incorporated herein by reference.

What is claimed is:

1. A non-aqueous electrolyte secondary battery comprising:
a negative electrode containing silicon as a negative electrode active material;
a positive electrode; and
a non-aqueous electrolyte containing electrolyte salts and a solvent, wherein
the non-aqueous electrolyte contains carbon dioxide, and the electrolyte salts in the non-aqueous electrolyte include LiBF₄ and another electrolyte salt that is less consumed relative to the LiBF₄ during charge-discharge cycling.

2. The non-aqueous electrolyte secondary battery according to claim 1, wherein the content of the LiBF₄ in the non-aqueous electrolyte is within a range of from 0.1 mol/L to 2.0 mol/L.

3. The non-aqueous electrolyte secondary battery according to claim 1, wherein the electrolyte salt other than the LiBF₄ is at least one substance selected from the group consisting of LiPF₆, LiN(SO₂C₂F₅)₂, and LiN(SO₂CF₃)₂.

4. The non-aqueous electrolyte secondary battery according to claim 2, wherein the electrolyte salt other than the LiBF₄ is at least one substance selected from the group consisting of LiPF₆, LiN(SO₂C₂F₅)₂, and LiN(SO₂CF₃)₂.

5. The non-aqueous electrolyte secondary battery according to claim 1, wherein the negative electrode active material is composed of a thin film containing silicon and is deposited on a current collector by sputtering or by vacuum evaporation.

6. The non-aqueous electrolyte secondary battery according to claim 2, wherein the negative electrode active material is composed of a thin film containing silicon and is deposited on a current collector by sputtering or by vacuum evaporation.

7. The non-aqueous electrolyte secondary battery according to claim 3, wherein the negative electrode active material is composed of a thin film containing silicon and is deposited on a current collector by sputtering or by vacuum evaporation.

8. The non-aqueous electrolyte secondary battery according to claim 4, wherein the negative electrode active material is composed of a thin film containing silicon and is deposited on a current collector by sputtering or by vacuum evaporation.

9. The non-aqueous electrolyte secondary battery according to claim 1, wherein the content of carbon dioxide in the non-aqueous electrolyte is 0.01 weight % or greater.

10. The non-aqueous electrolyte secondary battery according to claim 2, wherein the content of carbon dioxide in the non-aqueous electrolyte is 0.01 weight % or greater.

11. The non-aqueous electrolyte secondary battery according to claim 3, wherein the content of carbon dioxide in the non-aqueous electrolyte is 0.01 weight % or greater.

12. The non-aqueous electrolyte secondary battery according to claim 4, wherein the content of carbon dioxide in the non-aqueous electrolyte is 0.01 weight % or greater.

13. The non-aqueous electrolyte secondary battery according to claim 5, wherein the content of carbon dioxide in the non-aqueous electrolyte is 0.01 weight % or greater.

14. The non-aqueous electrolyte secondary battery according to claim 1, wherein the positive electrode shows a potential within a range of from 4.3 V to 4.5V versus Li/Li⁺ in a charged state.

15. The non-aqueous electrolyte secondary battery according to claim 2, wherein the positive electrode shows a potential within a range of from 4.3 V to 4.5V versus Li/Li⁺ in a charged state.

16. The non-aqueous electrolyte secondary battery according to claim 3, wherein the positive electrode shows a potential within a range of from 4.3 V to 4.5V versus Li/Li⁺ in a charged state.

17. The non-aqueous electrolyte secondary battery according to claim 4, wherein the positive electrode shows a potential within a range of from 4.3 V to 4.5V versus Li/Li⁺ in a charged state.

18. The non-aqueous electrolyte secondary battery according to claim 5, wherein the positive electrode shows a potential within a range of from 4.3 V to 4.5V versus Li/Li⁺ in a charged state.

19. The non-aqueous electrolyte secondary battery according to claim 9, wherein the positive electrode shows a potential within a range of from 4.3 V to 4.5V versus Li/Li⁺ in a charged state.

20. The non-aqueous electrolyte secondary battery according to claim 10, wherein the positive electrode shows a potential within a range of from 4.3 V to 4.5V versus Li/Li⁺ in a charged state.
